(19) United States
(12) Patent Application Publication
(10) Pub. No.: US 2026/0064341 A1
(43) Pub. Date: Mar. 5, 2026

(54) SYSTEM AND METHOD FOR WIRELESS VIDEO DISPLAY

(71) Applicant: Zoltan GELENCSER, Singapore (SG)

(72) Inventor: Zoltan GELENCSER, Singapore (SG)

(21) Appl. No.: 18/820,241

(22) Filed: Aug. 29, 2024

(51) Int. Cl. G06F 3/14; G06F 3/01; H04L 61/00; H04W 76/10

(52) U.S. Cl. CPC G06F 3/14; G06F 3/011; H04L 61/35; H04W 76/10

(57) ABSTRACT

A global wireless transmission device for a visual display system comprising an electronic display, the device configured to communicate with a cloud environment and receive data therefrom, the device comprising a communication connector configured to facilitate data transmission between said global wireless transmission device and an electronic display, a memory for storing a plurality of instructions for enabling data to be received from said cloud environment and for being displayed on the electronic display and a processor for executing said instructions.

### FIELD OF THE INVENTION

The present invention relates to global wireless video display devices such as head-mounted display devices, and in particular to video glasses.

### BACKGROUND OF THE INVENTION

Video glasses or other types of video displays often suffer from problems of portability and convenience. Even though headsets and video display glasses may be wearable, the video connection often requires a wire for communication, or at least a local wireless connection to a smartphone, for example through Bluetooth.

### SUMMARY OF THE INVENTION

The background art does not teach or suggest a user-friendly, cost-effective, and efficient solution in the field of wireless video glasses, in particular those which feature cellular connectivity for widespread and potentially global access.

The present invention, in at least some embodiments, comprises a global wireless transmission system designed for visual displays, particularly wearable displays such as head-mounted displays, glasses displays, goggles displays, and devices supporting virtual reality (VR), augmented reality (AR), mixed reality (MR), and extended reality (XR). The system also supports non-wearable displays like OLED screens, televisions, projectors, and more.

By “global wireless” it is meant any suitable data communication system that has widespread or even potentially global access, rather than purely local access, such as local Wi-Fi for example.

Currently available AR glasses and smart glasses are not “global wireless”. These connect to a smartphone locally by wire or “local wireless”local wireless, Wi-Fi, Bluetooth, etc.

By contrast, the glasses of the present invention are independent from any local connection to or through a smartphone (or other user computational device) via wire or local wireless, such as Wi-Fi, Bluetooth, etc.

The system comprises a global wireless transmission device that communicates with a cloud environment to receive data, which is then transmitted to an electronic display. The communication between the global wireless transmission device and the electronic display is facilitated by a communication connector, which may be wired for example. The wireless transmission device can be detachable from the electronic display, providing flexibility in the system's configuration.

The cloud environment can include various cloud services like AWS, Google Cloud, Azure, a local on-premises cloud server, or a Multi-access Edge Compute (MEC). The cloud environment houses a cloud application server, which operates a server application capable of transferring data, including audio and video data, to the global wireless transmission device. This data transfer is facilitated through a wireless connection that may include any suitable type of global or widespread access, including but not limited to cellular networks, LAN, WAN, or other computer networks.

The system may also include a control device, such as a smartphone, that can receive user commands and display information to the user. Based on the received user commands, the control device can send commands to the cloud application server, which then transmits data to the global wireless transmission device, causing a visual display to be displayed on the electronic display.

The global wireless transmission device is preferably registered with the cloud application server through an identifier, which can be associated with a web communication or other computer network communication protocol, such as a URI, URL, or URN. This identifier ensures that the wireless transmission device is properly identified by the cloud application server.

The global wireless transmission device and associated system provide a comprehensive solution for global wireless data transmission for visual displays, offering flexibility, ease of use, and high-quality display capabilities.

Implementation of the method and system of the present invention involves performing or completing certain selected tasks or steps manually, automatically, or a combination thereof.

Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit.

As software, selected steps of the invention could be implemented as a plurality of software instructions being executed by a computer using any suitable operating system.

In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof.

Specifically, several selected steps can be implemented by hardware or by software on an operating system, of a firmware, and/or a combination thereof.

For example, as hardware, selected steps of at least some embodiments of the disclosure can be implemented as a chip or circuit (e.g., ASIC).

As software, selected steps of at least some embodiments of the disclosure can be implemented as a number of software instructions being executed by a computer (e.g., a processor of the computer) using an operating system.

In any case, selected steps of methods of at least some embodiments of the disclosure can be described as being performed by a processor, such as a computing platform for executing a plurality of instructions.

Software (e.g., an application, computer instructions) which is configured to perform (or cause to be performed) certain functionality may also be referred to as a “module” for performing that functionality, and also may be referred to a “processor” for performing such functionality.

Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device.

Two or more of such devices in communication with each other may be a “computer network.”

### BRIEF DESCRIPTION OF THE DRAWINGS

The invention is herein described, by way of example only, with reference to the accompanying drawings.

With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention.

In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a non-limiting, exemplary wireless transmission system for a visual display;

FIG. 2 shows a wireless transmission device 200 in greater detail;

FIGS. 3A-7B show the components of wireless transmission device 200 in more detail;

FIG. 8 shows a system for connecting a user computational device to the previously described cloud application server; and

FIG. 9 shows a non-limiting, exemplary flow for managing data transmission to, and display by, the previously described electronic display.

### DETAILED DESCRIPTION OF AT LEAST SOME EMBODIMENTS

The present invention relates generally to global wireless data transmission systems and methods, and more particularly to a global wireless transmission device capable of facilitating various remote activities through cloud-based connectivity.

In at least one aspect, the present invention provides a global wireless transmission system comprising a cloud server, a wireless transmission device, and at least one display device. The display device may be selected from, but not limited to, a projector, a television, or augmented reality (AR) glasses. The global wireless transmission device is configured to establish a global wireless connection with the cloud server, receive data from said cloud server, and transmit said data wirelessly to the at least one display device.

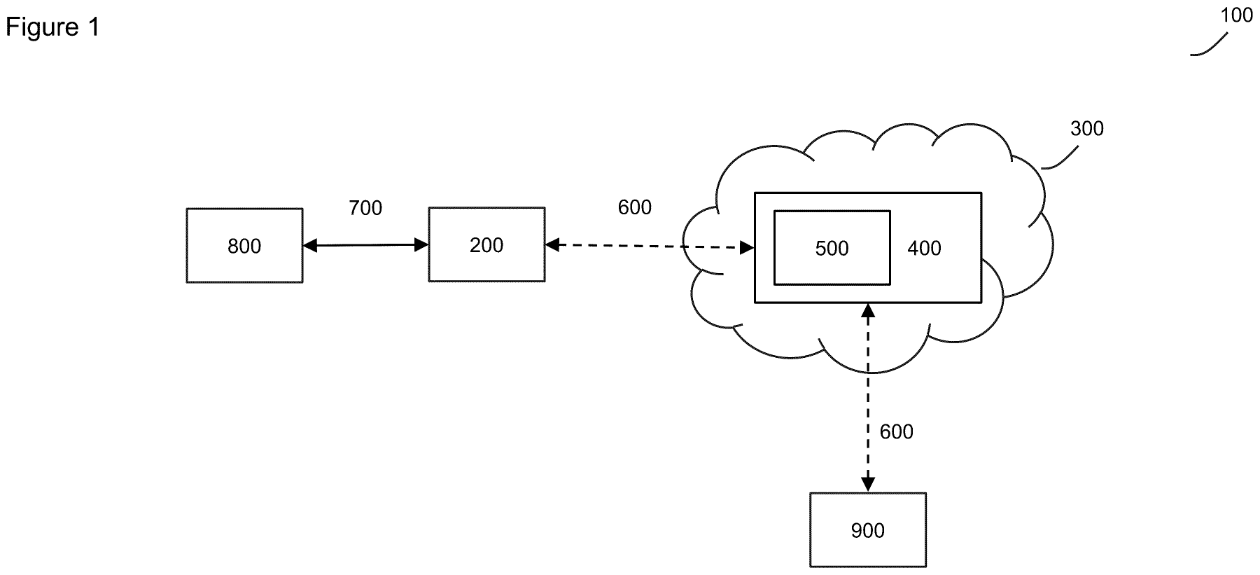

Turning now to the drawings, FIG. 1 shows a wireless transmission system for a visual display. As shown in a system 100, a global wireless transmission device 200 is able to communicate with a cloud environment 300. Global wireless transmission device 200 at least receives data from cloud environment 300, which is then transmitted to an electronic display 800. Electronic display 800 may comprise and/or be part of any suitable such display, including but not limited to a wearable display or a non-wearable display. Non-limiting examples of wearable displays include head mounted display, a glasses display, a goggles display, VR (virtual reality), AR (augmented reality), MR (mixed reality), XR (extended reality), and the like. Non-limiting examples of non-wearable displays include an OLED (Organic Light-Emitting Diode) screen, a television, a projector and the like.

Wearable electronic display 800 preferably at least receives data from global wireless transmission device 200 through a communication connector 700. Communication connector 700 may be wired. Communication connector 700, if wired, is physically connected to both wearable electronic display 800 and wireless transmission device 200. Communication connector 700 may comprise for example a DP (DisplayPort) connector, HDMI (High-Definition Multimedia Interface) connector, VDI (virtual desktop infrastructure) connector, or other suitable video and audio data connector.

Globla wireless transmission device 200 may be detachable from electronic display 800. If so, optionally wireless transmission device 200 comprises communication connector 700, such that both wireless transmission device 200 and communication connector 700 may be detachable from electronic display 800. Alternatively, electronic display 800 may comprise communication connector 700, such that transmission device 200 is detachable from communication connector 700.

Cloud environment 300 may include but is not limited to AWS (Amazon cloud service), Google cloud service, Azure (cloud service of Microsoft), a local on-premises cloud server and a MEC (Multi-access Edge Compute), or any other suitable cloud environment. Cloud environment 300 preferably comprises a cloud application server 400, which may comprise a processor and memory, a plurality of microservices and/or other suitable configurations. Cloud application server 400 is configured to operate a server application (not shown) which is able to cause data to be transferred to wireless transmission device 200. Such data preferably comprises audio and/or video data, and/or other types of suitable data. Such data may be transferred to wireless transmission device 200 from cloud environment 300 through a wireless connection 600. Wireless connection 600 may comprise any suitable wireless links and/or networks (including but not limited to cellular network, including but not limited to 3G, 4G, 5G, 6G and the like; LAN, WAN or other computer networks).

Global wireless connection 600 preferably also supports communication with a control device 900, which may comprise any suitable computational device, operating a set of instructions stored on a memory and executed by a processor. As a non-limiting example, control device 900 may comprise a smart phone, operating an app. Control device 900 is preferably able to receive user commands and to display information to the user. According to the received user commands, control device 900 is preferably able to send commands to cloud application server 400, which in turn transmits data to wireless transmission device 200. Such data causes a visual display to be displayed on electronic display 800, for example of video data.

To enable wireless transmission device 200 to be properly identified by cloud application server 400, preferably global wireless transmission device 200 is registered with cloud application server 400 through an identifier 500. Non-limiting examples of such identifiers include an identifier associated with a web communication or other computer network communication protocol, such as a URI (Uniform Resource Identifier), a URL (Uniform Resource Locator), a URN (Uniform Resource Name) and the like.

A Uniform Resource Identifier (URI) is a unique sequence of characters that identifies a logical or physical resource used by web technologies. URIs may be used to identify anything, including real-world objects, such as people and places, concepts, or information resources such as web pages and books. Some URIs provide a means of locating and retrieving information resources on a network (either on the Internet or on another private network, such as a computer filesystem or an Intranet); these are Uniform Resource Locators (URLs). A URL provides the location of the resource. A URI identifies the resource by name at the specified location or URL. Other URIs provide only a unique name, without a means of locating or retrieving the resource or information about it, these are Uniform Resource Names (URNs). The web technologies that use URIs include but are not limited to web browsers.

As a non-limiting example, global wireless device 200 connects to global wireless connection 600, upon which a Public IP address is dynamically assigned to the device by wireless connection 600. Dynamic in this context means that the network (wireless connection 600) potentially assigns a new IP address to wireless device 200 every time it connects to the network. Optionally and alternatively, the same IP address may be assigned to the same wireless device 200 for a longer period.

A fixed IP address is also possible.

As a non-limiting example of how this may operation, the following IP address 218.212.168.217 may be supposed to be assigned to wireless device 200 by the network. The port for receiving the video stream by wireless device 200 may be supposed to be 5555, for example. The IP address 218.212.168.217: 5555 is a valid URL (URI), however is difficult and impractical to remember such an address. Instead, preferably the Domain Name System (DNS) is used to translate e.g. the john-red-glasses. example-wire-less. com URL/URI/URN to 218.212.168.217: 5555. The user computational device 900 may be used to assign wireless device 200 and the server stream once.

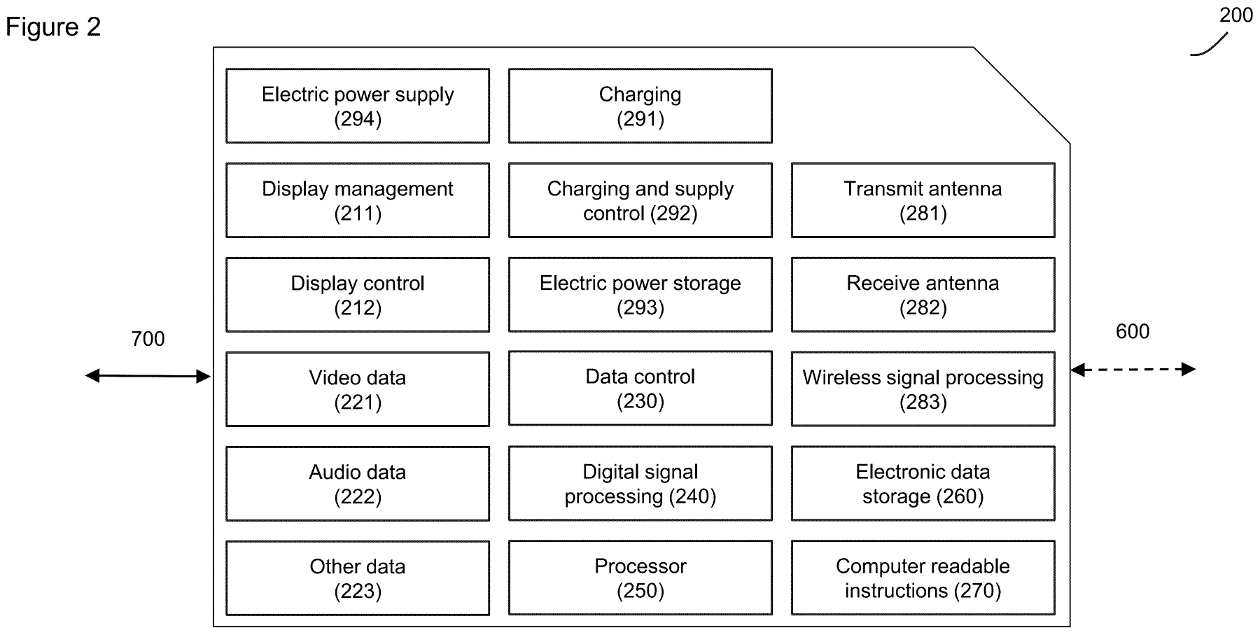

FIG. 2 shows a wireless transmission device 200 in greater detail. Components with the same reference numbers as in FIG. 1 have the same or at least similar function. As shown, global wireless transmission device 200 preferably features display management and control, which manages the provision of data to the electronic display (not shown, see FIG. 1). The display management and control enables data to be transmitted to communication connector 700 and hence to the electronic display, preferably through a display management 211 and a display control 212.

Display management 211 and display control 212 relate to two different, optional aspects of administering electronic display 800 connected to wireless transmission device 200.

Display management 211 preferably controls the overall configuration of the electronic display 800, including but not limited to resolution, refresh rate, and color settings. Non-limiting examples typically include connecting with commands from the built-in controls of an electronic display 800, such as buttons or a menu system for example.

Display control 212 preferably specifically controls the process in which wireless transmission device 200 interacts with electronic display 800. Non-limiting examples typically include sending video signals to the electronic display 800, controlling the display's power state, and detecting when the display is connected or disconnected.

Display management 211 may be controlled according to actions taken by the user (for example via a control device 900 which may for example comprise a user computer (not shown, see FIG. 1), while display control 212 may be controlled through global wireless transmission device 200.

Optionally, global wireless transmission device 200 may override the user's display settings (on the control device 900), non-limiting examples of which include a situation in which wireless transmission device 200 is trying to detect a new electronic display 800 or when electronic display 800 is not responding correctly.

Both electronic display management 211 and electronic display control 212 receive data from the previously described cloud services (not shown, see FIG. 1) through wireless connection 600 as shown.

A data processing module 252 handles data processing, including receiving data from the previously described cloud service (not shown, see FIG. 1) and then providing such data to the display management control as required. Such data may be received through a wireless transmission, which supports communication between wireless transmission device 200 and the previously described cloud service.

Received data may be stored in an electronic data storage 260, and may be processed by a processor 250. Processor 250 preferably executes instructions stored in a memory, shown as computer readable instructions 270. To execute the plurality of instructions for at least receiving data, and optionally also for transmission, processor 250 preferably executes instructions 270, optionally also according to data stored in electronic data storage 260.

Global wireless transmission device 200 may be powered through a power module as shown.

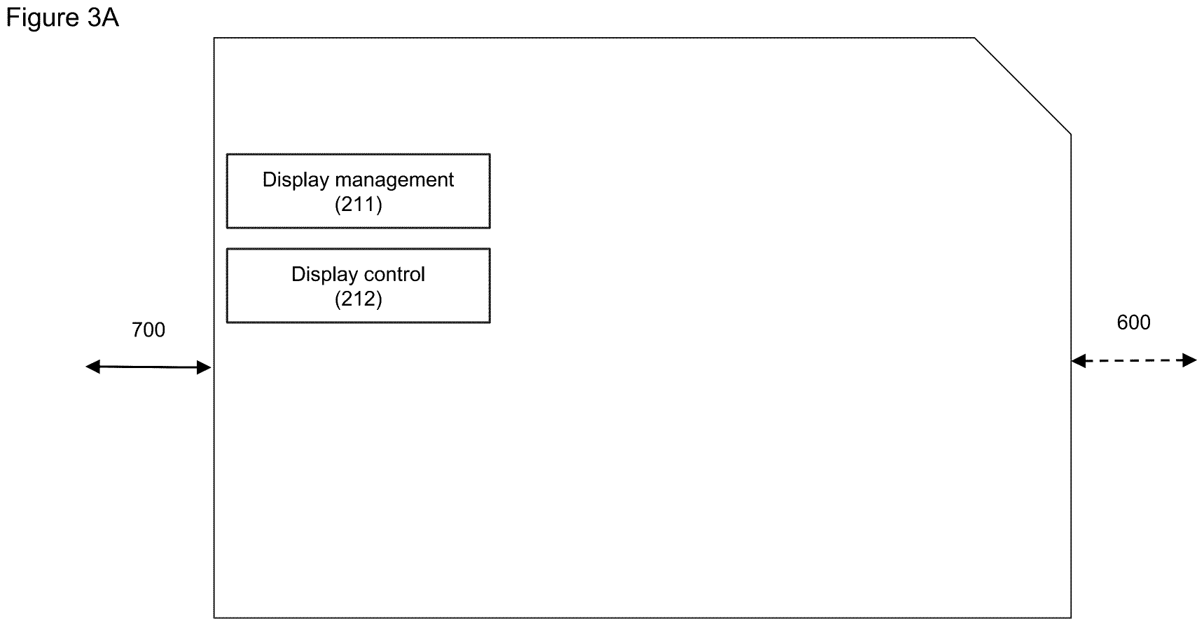

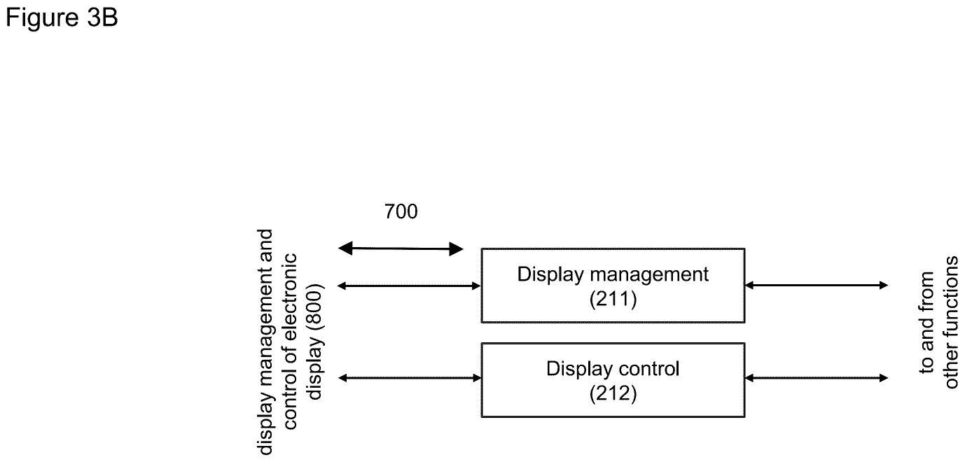

FIGS. 3A-7B show the components of wireless transmission device 200 in more detail. Components with the same reference numbers as in FIGS. 1 and 2 have the same or at least similar function.

Turning now to FIGS. 3A and 3B, management of the display is shown in more detail, comprising electronic display management 211 and electronic display control 212. Both electronic display management 211 and electronic display control 212 communicate with electronic display 800 (not shown, see FIG. 1) to handle the display management and control functions, through communication connector 700.

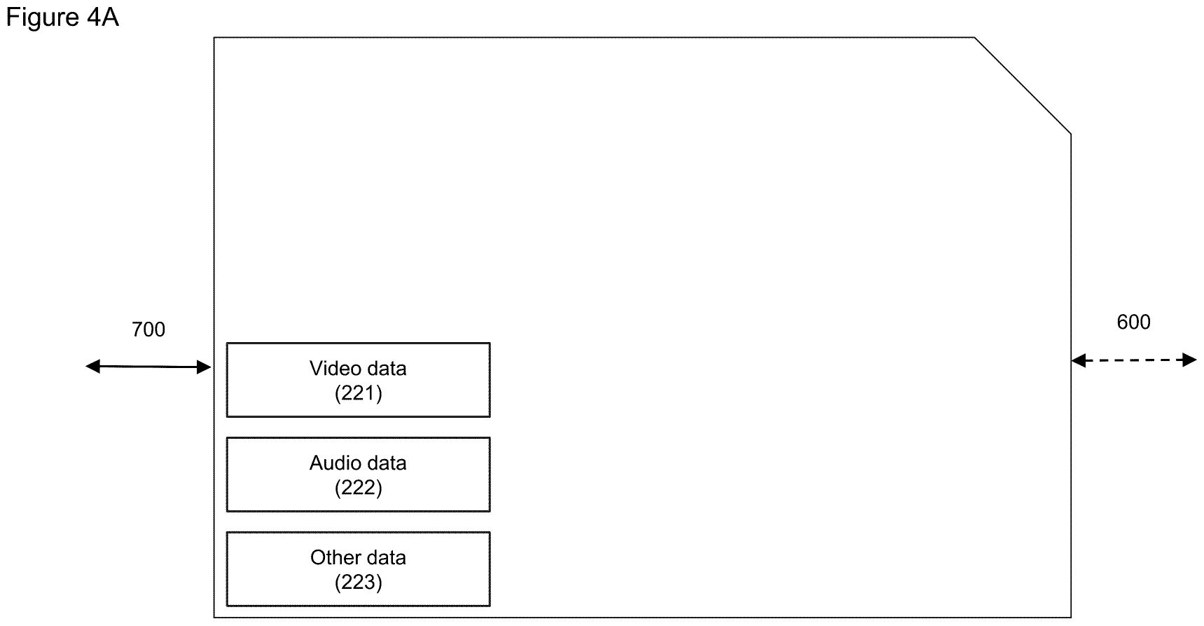

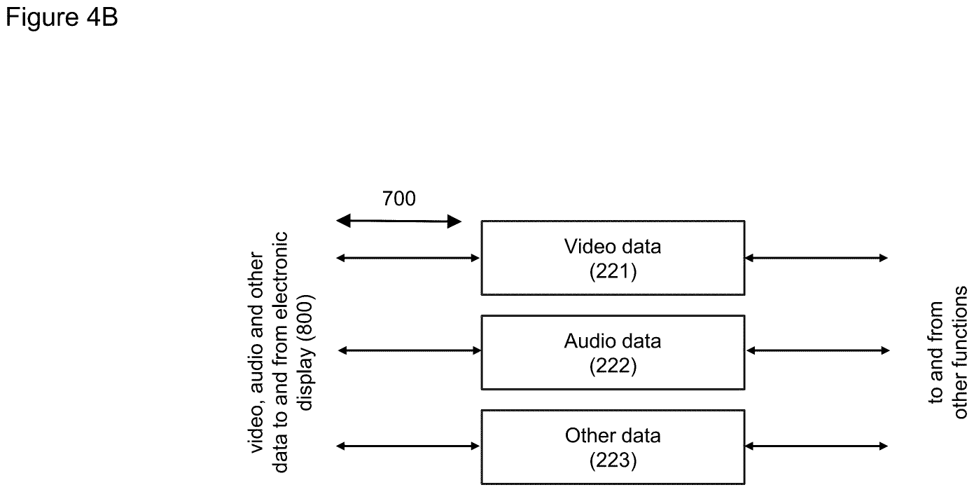

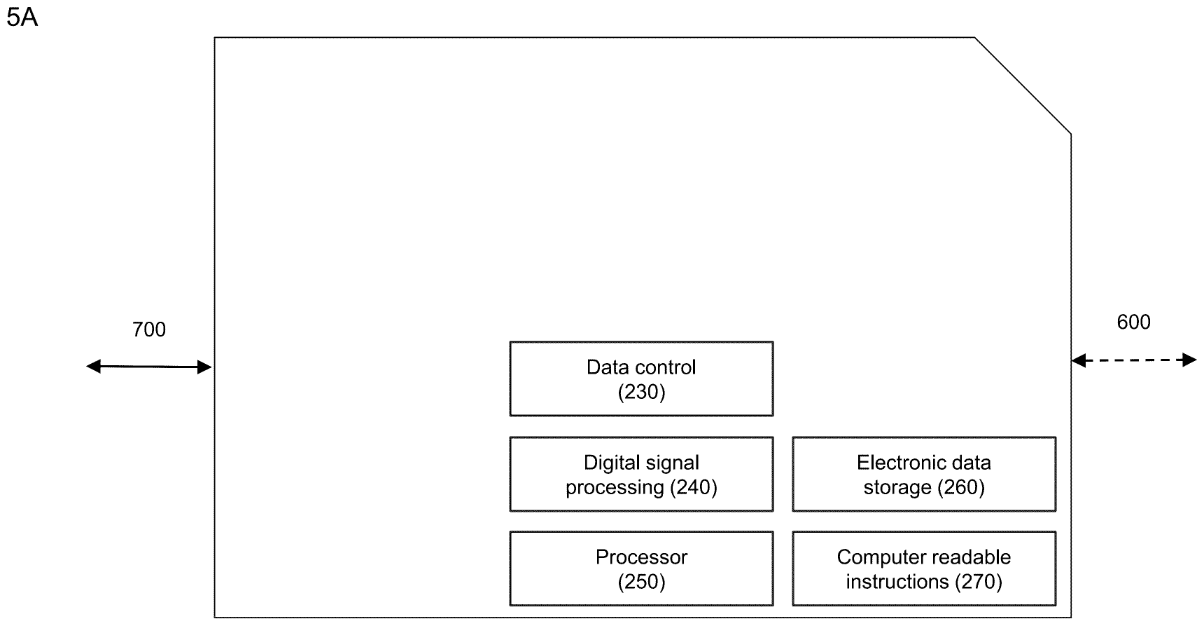

FIGS. 4A and 4B show how various types of data are handled through a data management system. The data management system is preferably able to handle video data 221, audio data 222, other data 223 and so forth. As shown in FIG. 4B, the data management system preferably communicates with other functions to at least receive such data for video data 221, audio data 222, other data 223 and so forth. Data management system then supports transmission of video, audio and/or other types of data to electronic display 800, through communication connector 700. Optionally and preferably, the data management system also supports transmission of video, audio and/or other types of data from wireless transmission device 200 to electronic display 800.

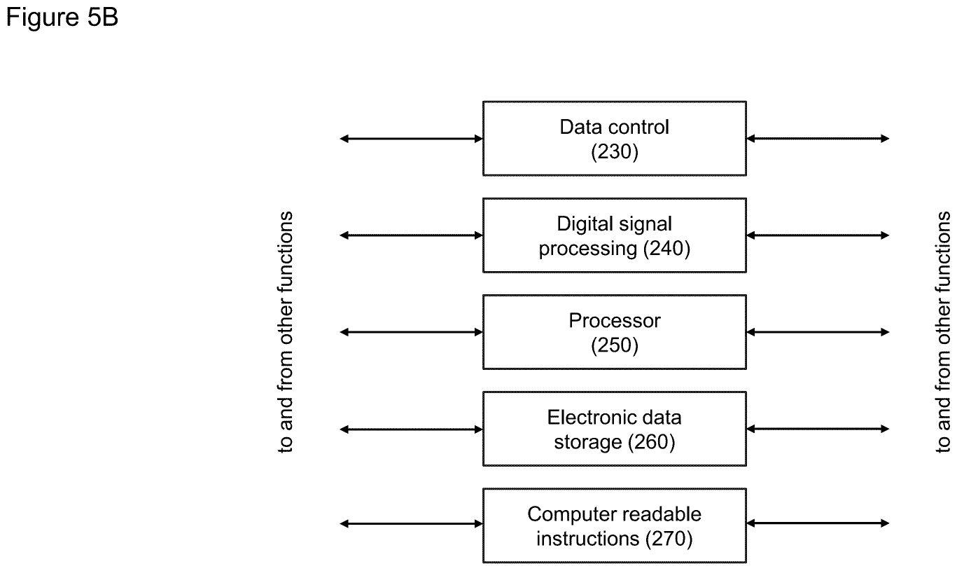

FIGS. 5A and 5B relate to data processing and control, and execution of instructions stored in a local memory. The components shown include electronic data storage 260, processor 250 and computer readable instructions 270. Such data processing and control further comprises receiving an IP stream (e.g. TCP or UPD) as global wireless input and converting it to a wired signal for the output (DisplayPort, HDMI etc.).

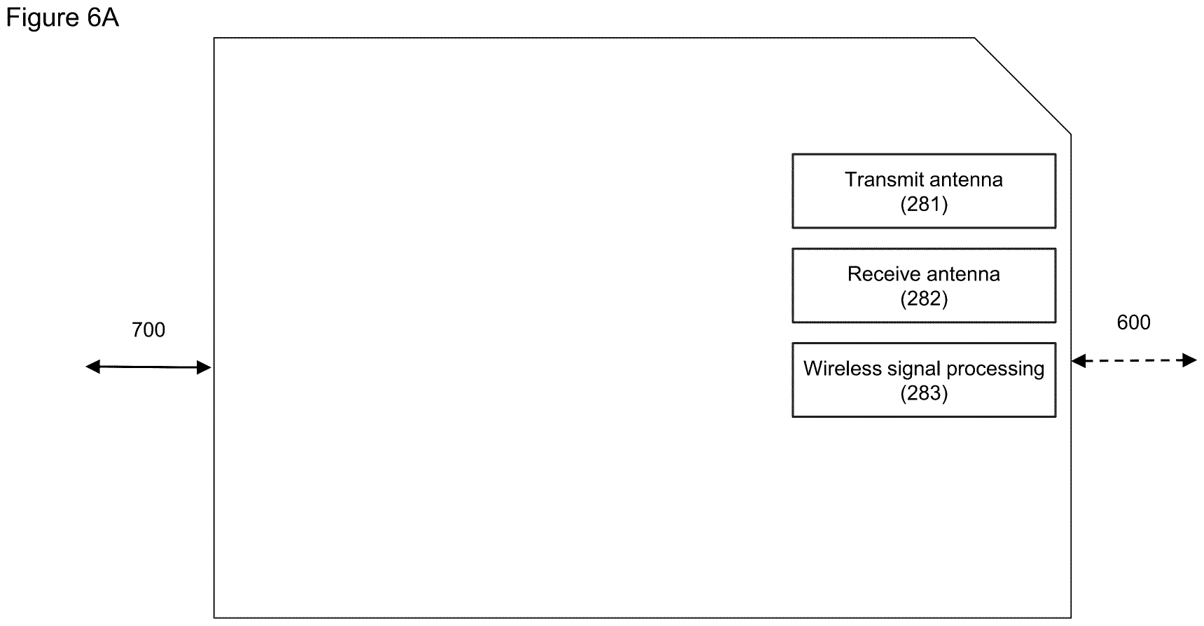

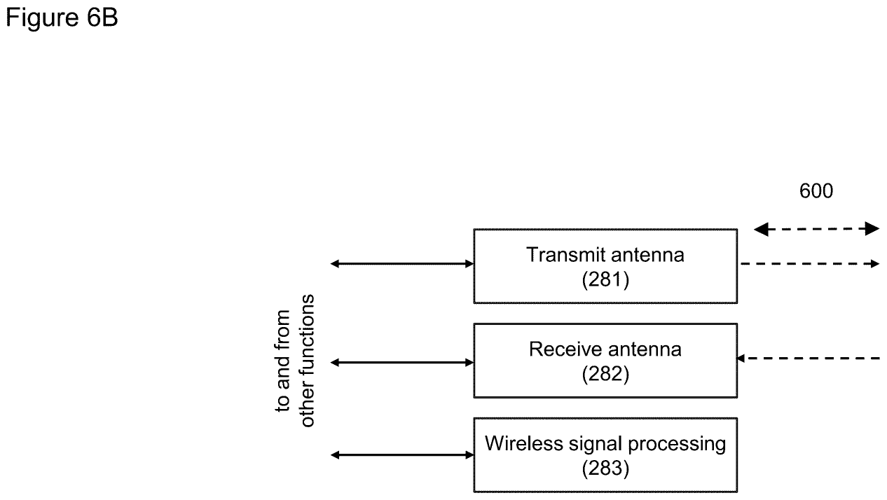

FIGS. 6A and 6B relate to at least receiving data from global wireless connection 600, and optionally transmitting data to wireless connection 600. As shown in FIGS. 6A and 6B, wireless transmission, which supports communication between global wireless transmission device 200 and the previously described cloud service, is shown in more detail. The global wireless transmission preferably handles at least receiving data from wireless connection 600.

The global wireless transmission comprises at least receive antenna 282, but optionally and preferably also comprises transmit antenna 281; again receive antenna 282 and transmit antenna 281 are optionally combined as a single transceiver. Wireless signal processing capabilities are preferably provided through wireless signal processor 283.

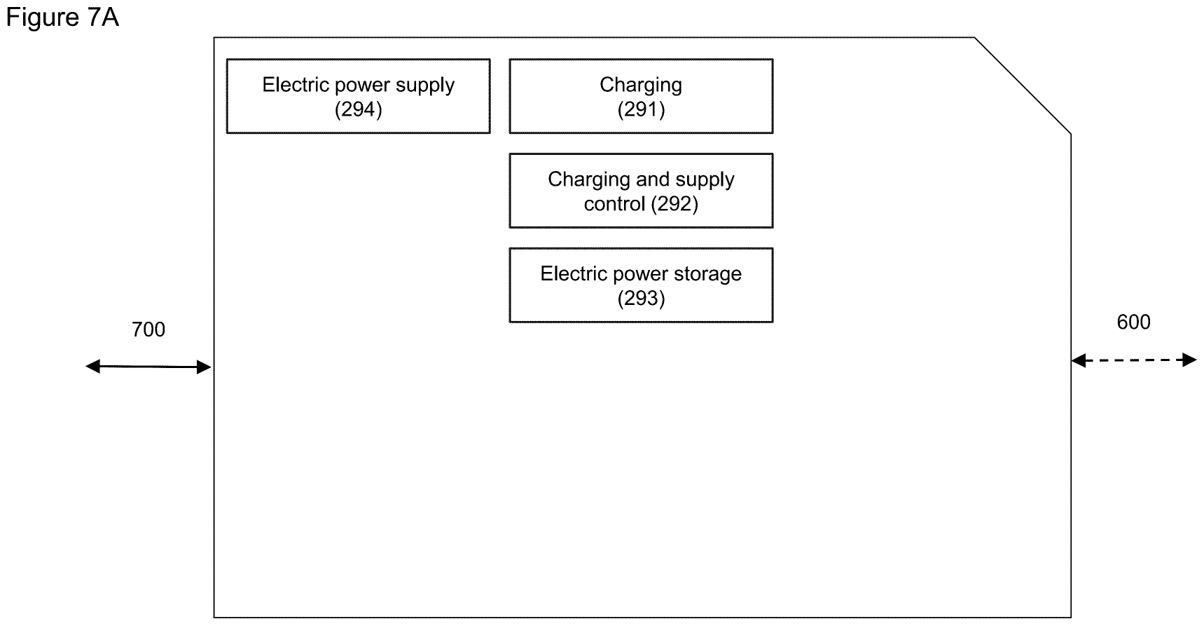

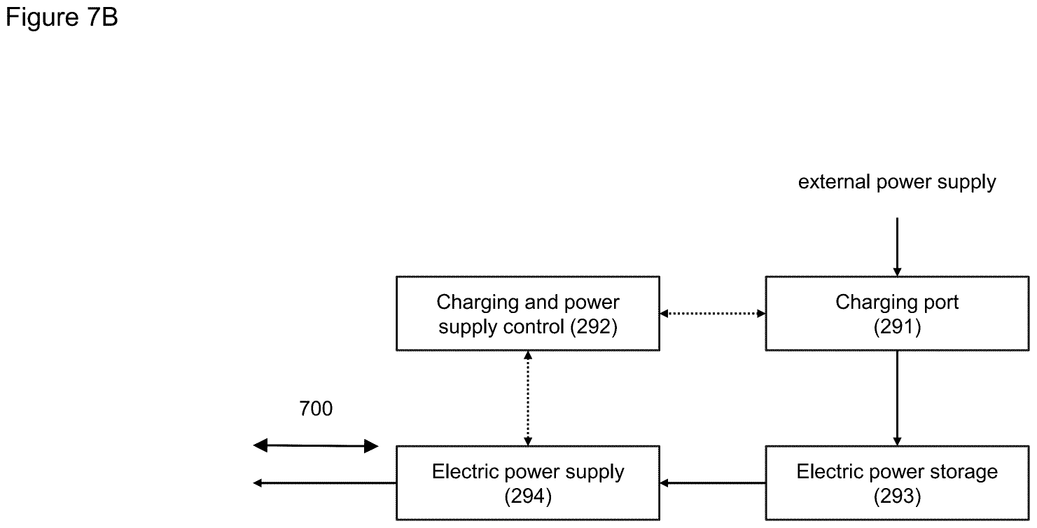

FIGS. 7A and 7B relate to electronic power management. Preferably, electronic power management is provided by a power module, which comprises electronic power supply 294, charging port 291, charging and supply control 292, and electric power storage 293. Charging port 291 enables electronic power supply 294 to be charged, such that wireless transmission device 200 preferably is not permanently connected to electronic mains power. Instead, once electronic power supply 294 is sufficiently charged, charging port 291 may be detached from an external power source. Electronic power supply 294 may comprise a battery, a supercapacitor or other suitable store of energy. Charging and supply control 292 preferably controls charging of electronic power supply 294 and the supply of power from electronic power supply 294.

Separate power storage may be provided by an electric power storage 293, which for example may comprise a battery, super capacitor, or other suitable power storage. Electronic power supply 294 may comprise a power source of wireless transmission device 200, for powering electronic display 800. Such a power source may be a secondary power source or a primary power source for electronic display 800. The latter situation may arise of electronic display does not have a built-in power source, and/or does not have an accessible or actuatable power source at the time of operation.

Turning to FIG. 7B, an external power supply (not shown) supplies power through charging port 291, whether through a wired connection, induction or the like. An electrical charge is then sent to electric power storage 293, which in turn provides power to electronic power supply 294. Preferably, charging and supply control 292 controls and manages both charging port 291 and electronic power supply 294. From electronic power supply 294, power is provided to the components of wireless transmission device 200, and may also be provided to the electronic display (not shown), for example through communication connector 700 (which may therefore also serve as a power connector).

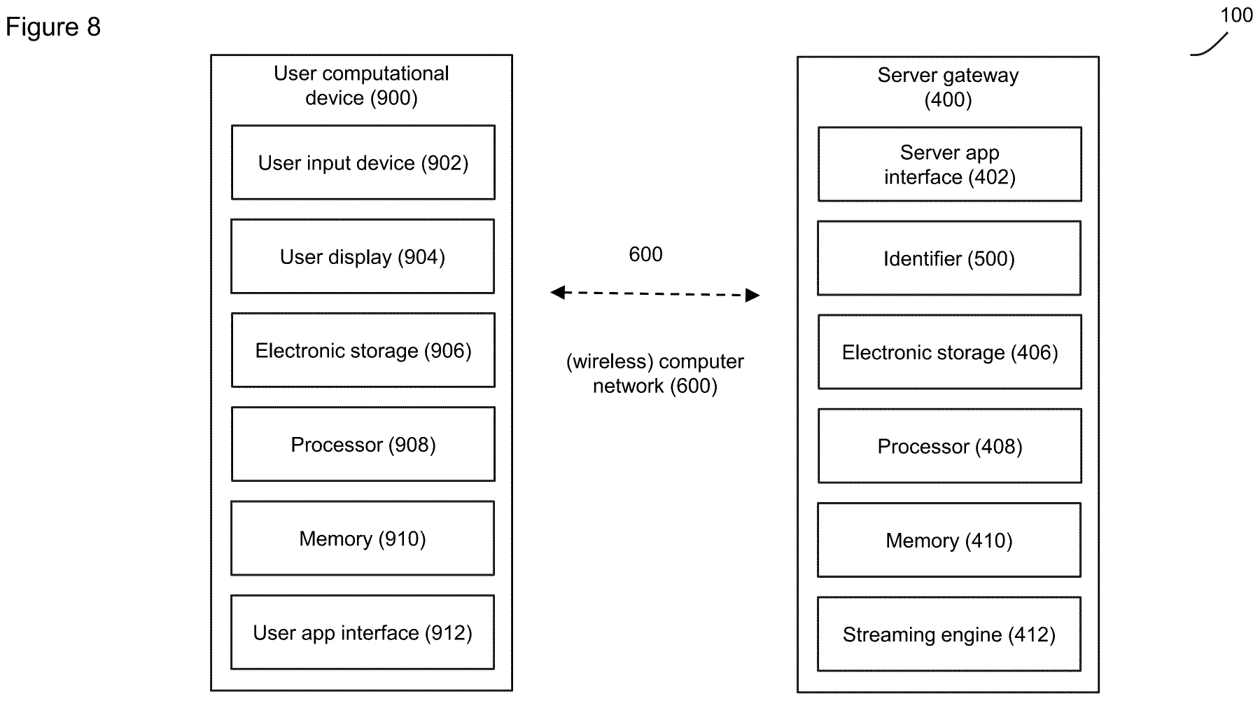

FIG. 8 shows a system for connecting a user computational device to the previously described cloud application server. As shown, a system 800 connects a user computational device 900 to cloud application server 400, through wireless connection 600. Optionally, communication is provided through a different computer network, which may be a wired computer network for example. Optionally, communication is provided through the internet.

User computational device 900 may be used to control one or more functions of wireless transmission device 200. For example, user computational device 900 may be used to control the display on wireless transmission device 200, which data is displayed, how it is displayed, and so forth.

User computational device 900 may comprise a user app interface 912 for receiving one or more commands from the user, and for displaying information about the functions of wireless transmission device 200 and/or the connection to cloud application server 400.

User computational device 900 also comprises a processor 908 and a memory 910.

Functions of processor 908 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

Processor 908 may further include functionality to operate one or more software programs based on computer-executable program code thereof, which may be stored in a memory, such as a memory 910 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 910 is configured for storing a defined native instruction set of codes. Processor 908 is configured to perform a defined set of basic operations in response to receiving a corresponding basic instruction selected from the defined native instruction set of codes stored in memory 910.

For example and without limitation, memory 910 may store a first set of machine codes selected from the native instruction set for displaying information through user app interface 912 regarding one or more functions of wireless transmitting device 200; a second set of machine codes selected from the native instruction set for receiving data from the user, regarding commands to be performed; and a third set of machine codes selected from the native instruction set for transmitting such information and data to cloud application server 400 for causing data to be returned to wireless transmitting device 200.

User computational device 900 also preferably includes user input device 902 and user display device 906. The user input device 904 may optionally be any type of suitable input device including but not limited to a keyboard, microphone, mouse, a keyboard/mouse combination or other pointing device and the like. User display device 904 is able to display information to the user for example from user app interface 912. Electronic storage may be provided through electronic storage 910, for example for additional data storage and the like.

Cloud application server 400 preferably comprises a processor 408 and a memory 410 with related or at least similar functions as for processor 908 and memory 910, including without limitation functions of cloud application server 400 as described herein. A server app interface 402 preferably enables cloud application server 400 to send and receive data, for example by communicating with user app interface 912 and global wireless transmission (not shown, see FIG. 2).

Data for display on global wireless transmission device 200 is preferably streamed through a streaming engine 412. Streaming engine 412 may receive such data, such as audio and/or video data for example, from an external data source (not shown) and/or through an electronic storage 410, which may also be used for example for additional data storage and the like. Non-limiting examples of streaming engine 412, which may be hosted in the cloud and are able to stream to a URL/URI/URN, include: OBS Studio (https://obsproject.com/); Wowza Streaming Engine (https://www.wowza.com/streaming-engine); Kaltura (https://corp.kaltura.com/kaltura-streaming-platform/); IBM Watson Media (Ustream; https://video.ibm.com/); Google Cloud Media Live (https://cloud.google.com/livestream/docs) and AWS Elemental MediaLive (https://aws.amazon.com/medialive/).

Non-limiting examples of suitable video streaming formats include: Real-Time Messaging Protocol (RTMP) by Adobe; Real-Time Streaming Protocol (RTSP), which is an open standard protocol that is used for controlling streaming media; HTTP Live Streaming (HLS), which is an open standard protocol that is based on HTTP; Dynamic Adaptive Streaming over HTTP (MPEG-DASH), which is an open standard protocol that is similar to HLS; Secure Reliable Transport (SRT), which is an open-source protocol that is designed for low-latency, high-quality video streaming; and Web Real-Time Communication (WebRTC), which is an open standard that allows for peer-to-peer video streaming.

Functions of cloud application server 400 are preferably supported through instructions stored at memory 410 and executed by processor 408. For example, instructions may be executed by processor 408 to support streaming engine 912 and/or to support the identification of wireless transmission device 200 through identifier 500, as previously described.

For example and without limitation, memory 410 may store a first set of machine codes selected from the native instruction set for receiving the information regarding identifier 500 from user computational device 900, a second set of machine codes selected from the native instruction set for confirming permitted access by user computational device 900, a third set of machine codes selected from the native instruction set for retrieving video data for transmission; a fourth set of machine codes selected from the native instruction set for executing functions of streaming engine 412; and a fifth set of machine codes selected from the native instruction set for transmitting the streaming data to wireless transmission device 200.

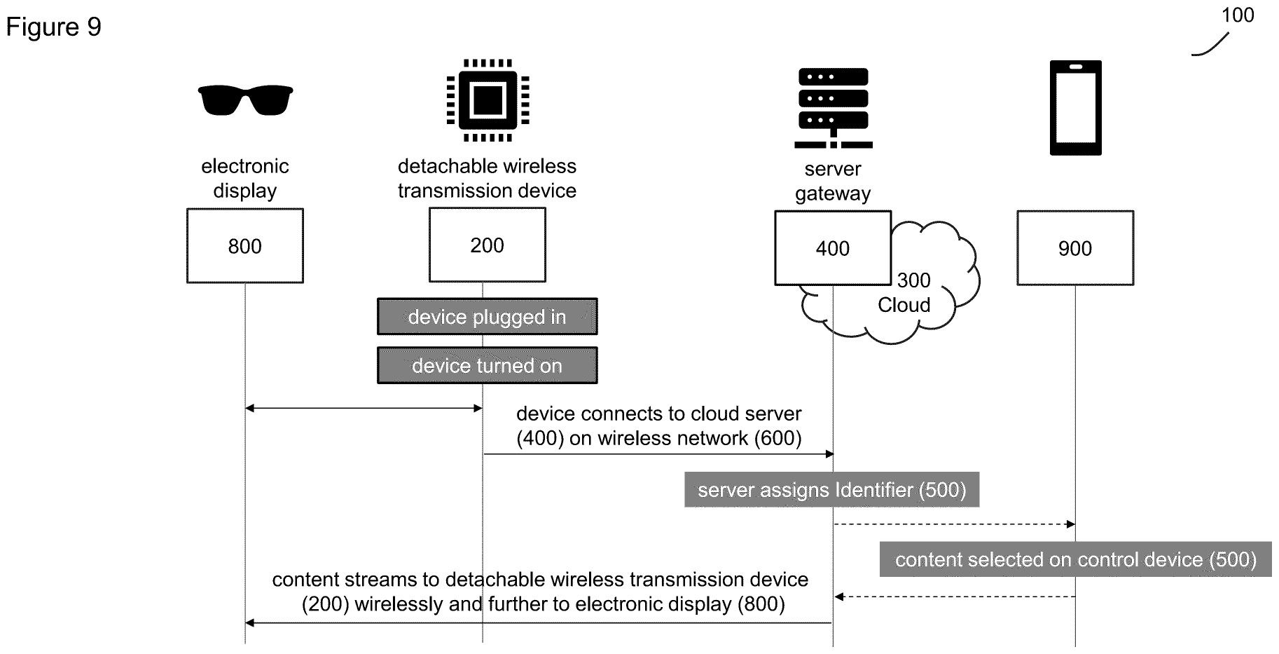

FIG. 9 shows a non-limiting, exemplary flow for managing data transmission to, and display by, the previously described electronic display. The flow occurs between electronic display 800, wireless transmission device 200 (which may or may not be detachable from electronic display 800), cloud server 400 and user computational device 900. Cloud server 400 operates through cloud 300 as shown.

In order for the flow to occur, electronic display 800 and wireless transmission device 200 need to be connected to each other, and need to be turned on. Electronic display 800 may have its own power source and/or may derive power from wireless transmission device 200.

Global wireless transmission device 200 may have its own power source and/or may derive power from electronic display 800.

Next, global wireless transmission device 200 connects to cloud server 400 through global wireless connection 600. Cloud server 400 assigns an identifier 500 to global wireless transmission device 200, optionally as a one-time assignment or alternatively as a permanent assignment (for example, to be able to connect to a particular resource). Cloud server 400 may transmit this identifier to an associated user computational device, such as user computational device 900. The user may then select content to stream by entering commands through user computational device 900, to be sent to cloud server 400. Preferably, the content then streams to global wireless transmission device 200 through global wireless connection 600 and further to electronic display 800.

The invention as described herein may be applied to a wide range of business and use cases. Without wishing to be limited by a closed list, some non-limiting examples include providing one or more of the following:
Wireless Presentation: The device facilitates the sharing of a cloud server's screen globally and wirelessly to a larger display, such as a projector, television, or AR glasses. This functionality enhances mobility and can be particularly advantageous for presentations, training sessions, or meetings in mobile settings.
Wireless Gaming: The device enables wireless streaming of video and audio from cloud-hosted games to a larger display or AR glasses. This feature promotes mobility and facilitates social gaming experiences in various locations.
Wireless Entertainment: The device allows streaming of media content, including but not limited to movies, television shows, or music, from a cloud server to a larger display or AR glasses. This functionality enhances the user's ability to enjoy content on a wearable larger screen, such as AR glasses, in mobile environments.
Mobile Collaboration: The device supports screen sharing capabilities, enabling multiple users to collaborate on projects or documents via the cloud server in mobile settings. This feature is particularly useful for remote brainstorming sessions or obtaining real-time feedback through AR glasses.
Wireless Remote Support: The device facilitates remote device control, allowing users to connect to and control remote devices as if physically present. This functionality is particularly beneficial for troubleshooting or providing technical support via AR glasses in mobile scenarios.

Without limiting the scope of the invention in any way, some advantages of the wireless transmission device include:
Wireless operation, eliminating the need for physical cable connections
Simplified setup and user interface
Broad device compatibility, supporting various protocols including, but not limited to, USB-C DisplayPort Alt Mode and HDMI
High-quality video and audio streaming capabilities

It should be understood that the aforementioned functionalities and advantages are provided as non-limiting examples, and the scope of the present invention may encompass additional features and benefits not explicitly described herein.

It is appreciated that certain features of the invention, which are, for clarity, described in the context of separate embodiments, may also be provided in combination in a single embodiment.

Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art.

Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference.

In addition, citation or identification of any reference in this application shall not be construed as an admission that such reference is available as prior art to the present invention.

What is claimed is:

1. A global wireless transmission device for a visual display system comprising an electronic display, the device configured to communicate with a cloud environment and receive data therefrom, the device comprising a communication connector configured to facilitate data transmission between said global wireless transmission device and an electronic display, a memory for storing a plurality of instructions for enabling data to be received from said cloud environment and for being displayed on the electronic display and a processor for executing said instructions.

2. The device of claim 1, wherein said communication connector is a wired connector.

3. The device of claim 1, configured to be detachable from the electronic display.

4. The device of claim 1, further comprising a display management and control for managing the provision of data to the electronic display.

5. The device of claim 4, wherein said display management and control comprises an electronic display management component and an electronic display control component.

6. The device of claim 1, further comprising a data processing module for handling data processing, including receiving data from a cloud service and providing such data to a display management and control.

7. The device of claim 6, wherein said data processing module comprises a data control component for providing control over at least receiving such data, and a digital signal processing component for handling digital signal processing for at least receiving such data.

8. The device of claim 1, further comprising a global wireless transmission component for supporting communication between said global wireless transmission device and a cloud service.

9. The device of claim 8, wherein said global wireless transmission component comprises at least a receive antenna, a transmit antenna and a wireless signal processor.

10. The device of claim 1, further comprising a power module for powering said wireless transmission device.

11. The device of claim 10, wherein said power module comprises an electronic power supply, a charging port, a charging and supply control, and an electric power storage.

12. A global wireless transmission system for a visual display, comprising: the global wireless transmission device of claim 1; and an electronic display configured to receive said data from said global wireless transmission device and display visual content based on said data.

13. The system of claim 12, wherein said electronic display is a wearable display.

14. The system of claim 13, further comprising a communication connector configured to facilitate data transmission between said global wireless transmission device and said electronic display.

15. The system of claim 14, wherein said communication connector is a wired connector.

16. The system of claim 15, wherein said global wireless transmission device is detachable from said electronic display.

17. The system of claim 16, wherein said cloud environment comprises a cloud application server configured to operate a server application that causes data to be transferred to said global wireless transmission device.

18. The system of claim 17, wherein said data comprises audio and video data.

19. The system of claim 18, further comprising a user computational device configured to receive user commands and display information to the user, and to send commands to said cloud application server based on said user commands.

20. The system of claim 19, wherein said global wireless transmission device is registered with said cloud application server through an identifier.

21. The system of claim 20, wherein said global wireless transmission device comprises a display management and control for managing the provision of data to said electronic display.
